(19) United States
(12) Patent Application Publication
(10) Pub. No.: US 2018/0025815 A1
(43) Pub. Date: Jan. 25, 2018

(54) TWO-COLOR SPIRAL STRIP INJECTION MACHINE BASED ON PLC CONTROL AND STRIP INJECTION METHOD THEREOF

(71) Applicants: DONGGUAN YINGTONG WIRE CO., LTD., Dongguan, Guangdong (CN); HUBEI YINGTONG ELECTRONICS CO., LTD, Xianning, Hubei (CN)

(72) Inventors: Hualiang Fu, Dongguan, Guangdong (CN); Xiang Wei, Dongguan, Guangdong (CN)

(73) Assignees: DONGGUAN YINGTONG WIRE CO., LTD., Dongguan, Guangdong (CN); HUBEI YINGTONG ELECTRONICS CO., LTD., Xianning, Hubei (CN)

(21) Appl. No.: 15/549,383

(22) PCT Filed: Feb. 28, 2015
(86) PCT No.: PCT/CN2015/073391

§ 371 Date: Aug. 8, 2017

(30) Foreign Application Priority Data
Feb. 9, 2015 (CN) 201510069121.6

(51) Int. Cl. H01B 13/14; B29C 45/16; B29C 45/14; B29C 45/78; B29C 45/74

(52) U.S. Cl. CPC H01B 13/14; B29C 45/78; B29C 45/74; B29C 45/14008; B29C 45/16; B29K 2995/0021; B29K 2705/10

(57) ABSTRACT

A two-color spiral strip injection machine based on PLC control, comprising: a frame having a strip injection machine body, a motor, a PLC control box and a transmission mechanism, wherein the motor is connected to the strip injection machine body via the transmission mechanism; the strip injection machine body includes a cast aluminum heating cylinder, a core regulating lead screw; the core regulating lead screw includes a copper wire inlet, a head and a snout; the snout is connected to the transmission mechanism; the cast aluminum heating cylinder includes a head flange and a sizing inlet; the head includes a strip injection nozzle, the cast aluminum heating cylinder further includes a temperature sensor; the control box includes a PLC control program; the automated two-color strip injection is implemented by obtaining the real-time monitoring and feedback information of the temperature sensor.

### BACKGROUND OF INVENTION

### 1. Field of the Invention

The present invention relates generally to strip injection machinery, and more particularly to a two-color spiral strip injection machine based on PLC control and its strip injection method, it is of wire and cable manufacturing technology.

### 2. Description of Related Art

The conventional wire or cable jacket is Unicolored, which has been unable to meet the present requirements for production and life. In order to upgrade the wire cable quality, enhance recognition and improve the wire appearance, some suppliers have manufactured two-color wire and cable. However, the working procedure is complex, the strip injection molding is required twice in general, and the shape is simplex, the production efficiency is low, the automaticity is low, and the production cost is high.

Therefore, it is urgent to develop an equipment and technique for completing two-color spiral strip injection at one time.

### SUMMARY OF THE INVENTION

The object of the present invention is to provide a provide a two-color spiral strip injection machine which is capable of forming a two-color thread line and capable of realizing automatic control based on PLC control in view of the deficiencies of the prior art.

In order to achieve the above, the technical scheme adopted in the present invention is: a two-color spiral strip injection machine based on PLC control, comprising: a frame having a strip injection machine body located in an upper part thereof, a motor located in a lower part thereof, a PLC control box and a transmission mechanism respectively located on right and left sides of the frame, wherein the motor is connected to the strip injection machine body via the transmission mechanism; the strip injection machine body includes a cast aluminum heating cylinder, a core regulating lead screw disposed on a left of the cast aluminum heating cylinder; the core regulating lead screw includes a copper wire inlet disposed in a middle thereof, a head and a snout being connected to a right side of thereof; the snout is connected to the transmission mechanism; the cast aluminum heating cylinder includes a head flange located in a rear end thereof and a sizing inlet located in a center of the head flange; the head includes a strip injection nozzle located in an upper part thereof, the head is connected to the snout via a transmission shaft; the snout includes an outlet located in a middle thereof; the cast aluminum heating cylinder further includes a temperature sensor disposed thereon; the control box includes a PLC control program installed therein; the automated two-color strip injection is implemented by obtaining the real-time monitoring and feedback information of the temperature sensor.

More preferably, wherein the cast aluminum heating cylinder includes a heating cylinder supply socket located in a front part thereof, the PLC control box is connected to the heating cylinder supply socket via a heating cylinder power regulating plug for supplying power to the cast aluminum healing cylinder; the temperature sensor is located in an upper part of the cast aluminum heating cylinder; the temperature sensor is coupled to the cast aluminum heating cylinder to monitor and feedback the temperature of cast aluminum heating cylinder instantly.

More preferably, wherein the snout includes a heating plate located in a front part thereof and a heating plate supply socket disposed on the heating plate; the heating plate supply socket is connected to the PLC control box via the heating plate power regulating plug.

More preferably, wherein the head includes a strip injection inner eye mold and a strip injection outer eye mold disposed therein, and a sizing flow channel disposed between the strip injection inner eye mold and the strip injection outer eye mold; the strip injection inner eye mold is formed as a tapered shape, and includes a copper wire transfer passage located in a middle part thereof; the strip injection outer eye mold includes an upper strip injection outer eye mold, a lower strip injection outer eye mold, and a strip injection channel disposed on the upper strip injection outer eye mold; one end of the strip injection inner eye mold is coupled to the core regulating lead screw, and the coupling end is provided with a screw thread.

More preferably, wherein the transmission mechanism includes a driving gear set and a chain.

A strip injection method of the two-color spiral strip injection machine based on PLC control, comprising:

(1) start, and PLC control program is initialized;

(2) the PLC control program actuates the cast aluminum heating cylinder (5) and heating plate (17);

(3) set the copper wire machine, when the temperature reaches working temperature, under the control of PLC, the copper wire is fed in the cast aluminum heating cylinder (5) through copper wire inlet (7) automatically;

(4) when the copper wire enters the cast aluminum heating cylinder (5), the sizing A is injected into the sizing inlet, meanwhile the sizing B is injected into the strip injection nozzle 11;

(5) when the sizing A and sizing B have entered the strip injection machine, they are molten at working temperature, and sizing B adheres to the surface of sizing A, forming two-color sizing;

(6) the transmission mechanism drives said outer eye mold to rotate, when the copper wire is being transported, the sizing adheres to copper wire helically, the sizing is cooled and solidified outside the outer eye mold, the two-color spiral strip injection line is obtained,

More preferably, wherein the step (A1) includes PLC control program initialization, when the strip injection parameters are imported, whether the operation of various sensors is normal or not is checked automatically; if a sensor cannot work normally, an alarm is raised, and the PLC control box displays the location of the faulted sensor; the temperature control method of said PLC control program is;

(11) in the initial operation of equipment, the PLC control box exports 10A current via the heating cylinder power regulating plug and heating plate power regulating plug, so that the heating plate and heating cylinder are heated rapidly; when the temperature is 5° C. away from the preset working temperature, the heating cylinder power regulating plug and heating plate power regulating plug are controlled to export 7A current for slow heating; when the preset working temperature is reached, 5A current is exported for thermal insulation;

(12) in the operation of equipment at preset working temperature, if the present temperature detected by temperature sensor is lower than the preset working temperature by 1˜5° C., the output current is regulated to 7A for heating; if current temperature is lower than the preset working temperature by over 5° C., the output current is regulated to 10A for heating;

(13) if the present temperature detected by temperature sensor is higher than the preset working temperature by 1˜5° C., the output current is regulated to 2A for thermal insulation; if current temperature is higher than the preset working temperature by over 5° C., stop heating, when it is cooled to the preset working temperature, 5A current is supplied continuously for thermal insulation.

More preferably, wherein the step (2) includes regulating the core regulating lead screw automatically and controlling the screw thread size according to the input parameters;

the working temperature in step (3) and (5) is 80˜120° C.

More preferably, wherein the step (6) includes the sizing A is in the strip injection inner eye mold, covering the external surface of copper wire under the pressure effect; meanwhile, the sizing B adheres to the surface of sizing A through the outer eye mold, forming screw thread on the surface of sizing A while the outer eye mold is rotating.

More preferably, wherein the sizing A and sizing B are homogeneous or heterogeneous sizing of different colors, and the sizing flow channel is larger than the strip injection channel.

Effect of the present invention; the strip injection machine and technique provided by the present invention can mold two-color spiral strip injection at one time under PLC control, replacing the multiple steps of conventional two-molding, so as to obtain spiral two-tone color strip injection line, the production efficiency is increased greatly. The present invention sets a control box and a temperature sensor, the control box, sensor and built-in software work with each other to implement automated production of strip injection line, the production cost is reduced and the product quality is upgraded.

### BRIEF DESCRIPTION OF DRAWINGS

FIG. 1 is a schematic view of a two-color spiral strip injection machine based on plc control of the present invention;

FIG. 2 is an exploded view of the two-color spiral strip injection machine based on plc control of the present invention.

### DETAILED DESCRIPTION OF THE INVENTION

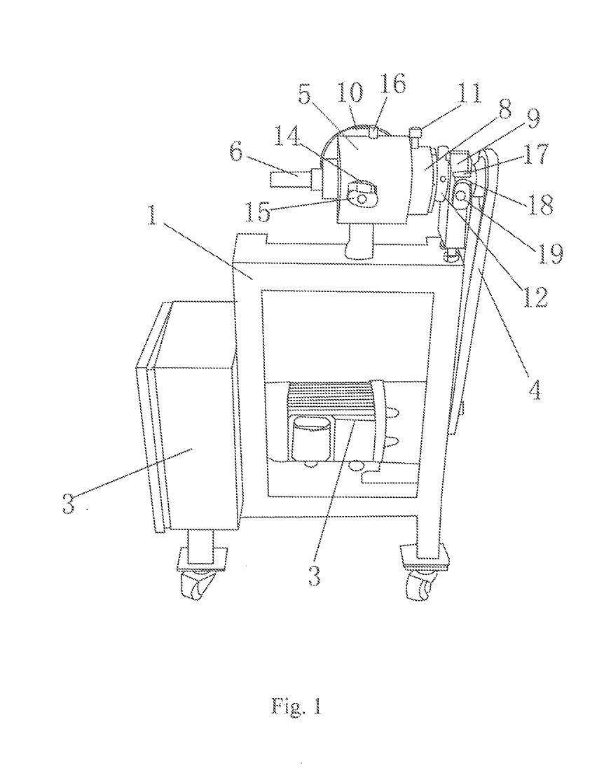

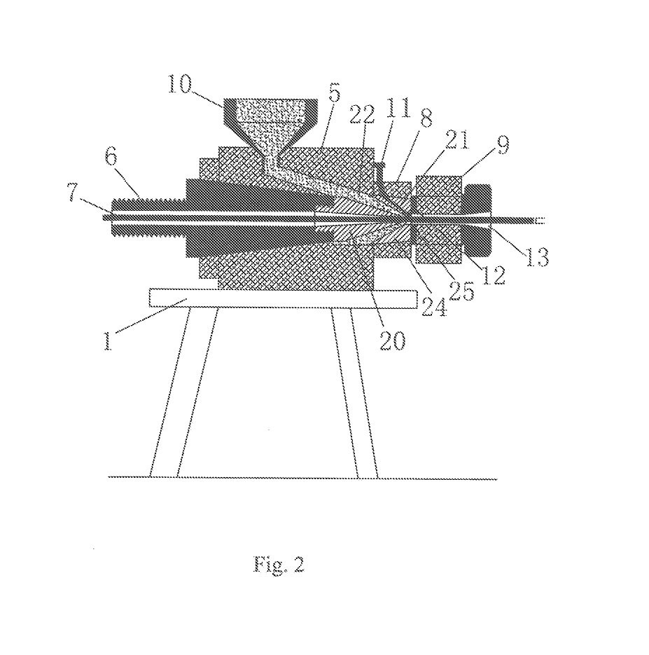

Referring to FIG. 1 and FIG. 2, this case provides a two-color spiral strip injection machine based on PLC control, including a frame 1, the strip injection machine body is located in the upper part of the frame 1, a motor 2 is located in the lower part. A PLC control box 3 and a transmission mechanism 4 are located on the right and left sides of frame 1. Said motor 2 is connected to the strip injection machine body via transmission mechanism 4. Said strip injection machine body contains a cast aluminum heating cylinder 5. A core regulating lead screw 6 is located on the left of cast aluminum heating cylinder 5. A copper wire inlet 7 is located in the middle of the core regulating lead screw 6, and a head 8 and a snout 9 are connected to the right side. Said snout 9 is connected to transmission mechanism 4. A head flange 10 is located in the rear end of cast aluminum heating cylinder 5. A sizing inlet is located in the center of the head flange 10. A strip injection nozzle 11 is located in the upper part of said head 8. Said head 8 is connected to the snout 9 via a transmission shaft 12. An outlet 13 is located in the middle of said snout 9. A temperature sensor 16 is located on said cast aluminum heating cylinder 5. The PLC control program is provided in said PLC control box 3. The automated two-color strip injection is implemented by obtaining the real-time monitoring and feedback information of the temperature sensor 16.

A heating cylinder supply socket 14 is located in the front part of said cast aluminum heating cylinder 5. The PLC control box 3 is connected to the heating cylinder supply socket 14 via a heating cylinder power regulating plug 15 for supplying power to the cast aluminum heating cylinder 5. The temperature sensor 16 is located in an upper part of the cast aluminum heating cylinder 5. The temperature sensor 16 is coupled to the cast aluminum heating cylinder 5 to monitor and feedback the temperature of cast aluminum heating cylinder 5 instantly.

A heating plate 17 is located in the front part of said snout 9. A heating plate supply socket 18 is located in the heating plate 17. The heating plate supply socket 18 is connected to the PLC control box 3 via the heating plate power regulating plug 19.

Said transmission mechanism 4 comprises driving gear set and chain.

A strip injection inner eye mold 20 and a strip injection outer eye mold are located in said head 8, and a sizing flow channel 22 is located between strip injection inner eye mold 20 and strip injection outer eye mold.

Said strip injection inner eye mold 20 is tapered, and a copper wire transfer passage 23 is located in the middle part.

Said strip injection outer eye mold comprises upper strip injection outer eye mold 21 and lower strip injection outer eye mold 24, a strip injection channel 25 is located on the upper strip injection outer eye mold.

One end of said strip injection inner eye mold 20 is connected to said core regulating lead screw 6, and the coupling end is provided with screw thread.

The strip injection method of said two-color spiral strip injection machine based on PLC control comprises the following steps:

(1) Start, PLC control program is initialized;

(2) The PLC control program actuates the cast aluminum heating cylinder 5 and heating plate 17;

(3) Set the copper wire machine, when the temperature reaches working temperature, under the control of PLC, the copper wire is fed in the cast aluminum heating cylinder 5 through copper wire inlet 7 automatically;

(4) When the copper wire enters the cast aluminum heating cylinder 5, the sizing A is injected into the sizing inlet, meanwhile the sizing 8 is injected into the strip injection nozzle 11;

(5) When the sizing A and sizing B have entered the strip injection machine, they are molten at working temperature, and sizing B adheres to the surface of sizing A, forming two-color sizing;

(6) The transmission mechanism drives said outer eye mold to rotate, when the copper wire is being transported, the sizing adheres to copper wire helically, the sizing is cooled and solidified outside the outer eye mold, the two-color spiral strip injection line is obtained.

Said Step (1) includes PLC control program initialization, when the strip injection parameters are imported, whether the operation of various sensors is normal or not is checked automatically. If a sensor cannot work normally, an alarm is raised, and the PLC control box displays the location of the faulted sensor. The temperature control method of said PLC control program is:

(11) In the initial operation of equipment, the PLC control box exports 10A current via the heating cylinder power regulating plug and heating plate power regulating plug, so that the heating plate and heating cylinder are heated rapidly. When the temperature is 5° C. away from the preset working temperature, the heating cylinder power regulating plug and heating plate power regulating plug are controlled to export 7A current for slow heating. When the preset working temperature is reached, 5A current is exported for thermal insulation.

(12) In the operation of equipment at preset working temperature, if the present temperature detected by temperature sensor is lower than the preset working temperature by 1˜5° C., the output current is regulated to 7A for heating. If current temperature is lower than the preset working temperature by over 5° C., the output current is regulated to 10A for heating.

(13) If the present temperature detected by temperature sensor is higher than the preset working temperature by 1˜5° C., the output current is regulated to 2A for thermal insulation. If current temperature is higher than the preset working temperature by over 5° C., stop heating, when it is cooled to the preset working temperature, 5A current is supplied continuously for thermal insulation.

Said Step (2) includes regulating the core regulating lead screw 6 automatically and controlling the screw thread size according to the input parameters.

Said working temperature in Step (3) is 80˜120° C.

Said, sizing A and sizing B are homogeneous or heterogeneous sizing of different colors, and the sizing flow channel is larger than the strip injection channel. When the sizing A and sizing B are heterogeneous sizing, the product strength is enhanced or more artistic three-dimensional pattern is obtained.

Said Step (6) includes: the sizing A is in the strip injection inner eye mold 20, covering the external surface of copper wire under the pressure effect; meanwhile, the sizing B adheres to the surface of sizing A through the outer eye mold, forming screw thread on the surface of sizing A while the outer eye mold is rotating.

The above only describes some exemplary embodiments of the present invention. Those having ordinary skills in the art may also make many modifications and improvements without departing from the conception of the invention, which shall all fall within the protection scope of the invention.

We claim

1. A two-color spiral strip injection machine based on PLC control, comprising:
a frame having a strip injection machine body located in an upper part thereof, a motor located in a lower part thereof, a PLC control box and a transmission mechanism respectively located on right and left sides of the frame, wherein the motor is connected to the strip injection machine body via the transmission mechanism; the strip injection machine body includes a cast aluminum heating cylinder, a core regulating lead screw disposed on a left of the cast aluminum heating cylinder; the core regulating lead screw includes a copper wire inlet disposed in a middle thereof, a head and a snout being connected to a right side of thereof; the snout is connected to the transmission mechanism; the cast aluminum heating cylinder includes a head flange located in a rear end thereof and a sizing inlet located in a center of the head flange; the head includes a strip injection nozzle located in an upper part thereof, the head is connected to the snout via a transmission shaft; the snout includes an outlet located in a middle thereof; the cast aluminum heating cylinder further includes a temperature sensor disposed thereon; the control box includes a PLC control program installed therein; the automated two-color strip injection is implemented by obtaining the real-time monitoring and feedback information of the temperature sensor.

2. The two-color spiral strip injection machine based on PLC control according to claim 1, wherein the cast aluminum heating cylinder includes a heating cylinder supply socket located in a front part thereof, the PLC control box is connected to the heating cylinder supply socket via a heating cylinder power regulating plug for supplying power to the cast aluminum heating cylinder; the temperature sensor is located in an upper part of the cast aluminum heating cylinder; the temperature sensor is coupled to the cast aluminum heating cylinder to monitor and feedback the temperature of cast aluminum heating cylinder instantly.

3. The two-color spiral strip injection machine based on PLC control according to claim 1, wherein the snout includes a heating plate located in a front part thereof and a heating plate supply socket disposed on the heating plate; the heating plate supply socket is connected to the PLC control box via the heating plate power regulating plug.

4. The two-color spiral strip injection machine based on PLC control according to claim 1, wherein the head includes a strip injection inner eye mold and a strip injection outer eye mold disposed therein, and a sizing flow channel disposed between the strip injection inner eye mold and the strip injection outer eye mold;
the strip injection inner eye mold is formed as a tapered shape, and includes a copper wire transfer passage located in a middle part thereof;
the strip injection outer eye mold includes an upper strip injection outer eye mold, a lower strip injection outer eye mold, and a strip injection channel disposed on the upper strip injection outer eye mold;
one end of the strip injection inner eye mold is coupled to the core regulating lead screw, and the coupling end is provided with a screw thread.

5. The two-color spiral strip injection machine based on PLC control according to claim 1, wherein the transmission mechanism includes a driving gear set and a chain.

6. A strip injection method of the two-color spiral strip injection machine based on PLC control, comprising:
(1) start, and PLC control program is initialized;
(2) the PLC control program actuates the cast aluminum heating cylinder (5) and heating plate (17);
(3) set the copper wire machine, when the temperature reaches working temperature, under the control of PLC, the copper wire is fed in the cast aluminum heating cylinder (5) through copper wire inlet (7) automatically;
(4) when the copper wire enters the cast aluminum heating cylinder (5), the sizing A is injected into the sizing inlet, meanwhile the sizing B is injected into the strip injection nozzle 11;
(5) when the sizing A and sizing B have entered the strip injection machine, they are molten at working temperature, and sizing B adheres to the surface of sizing A, forming two-color sizing;
(6) the transmission mechanism drives said outer eye mold to rotate, when the copper wire is being transported, the sizing adheres to copper wire helically, the sizing is cooled and solidified outside the outer eye mold, the two-color spiral strip injection line is obtained.

7. The strip injection method of the two-color spiral strip injection machine based on PLC control according to claim 6, wherein the step
(1) includes PLC control program initialization, when the strip injection parameters are imported, whether the operation of various sensors is normal or not is checked automatically; if a sensor cannot work normally, an alarm is raised, and the PLC control box displays the location of the faulted sensor; the temperature control method of said PLC control program is:
(11) in the initial operation of equipment, the PLC control box exports 10A current via the heating cylinder power regulating plug and heating plate power regulating plug, so that the heating plate and heating cylinder are heated rapidly; when the temperature is 5° C. away from the preset working temperature, the heating cylinder power regulating plug and heating plate power regulating plug are controlled to export 7A current for slow heating; when the preset working temperature is reached, 5A current is exported for thermal insulation;
(12) in the operation of equipment at preset working temperature, if the present temperature detected by temperature sensor is lower than the preset working temperature by 1˜5° C., the output current is regulated to 7A for heating; if current temperature is lower than the preset working temperature by over 5° C., the output current is regulated to 10A for heating;
(13) if the present temperature detected by temperature sensor is higher than the preset working temperature by 1˜5° C., the output current is regulated to 2A for thermal insulation; if current temperature is higher than the preset working temperature by over 5° C., stop heating, when it is cooled to the preset working temperature, 5A current is supplied continuously for thermal insulation.

8. The strip injection method of the two-color spiral strip injection machine based on PLC control according to claim 6, wherein the step (2) includes regulating the core regulating lead screw automatically and controlling the screw thread size according to the input parameters; the working temperature in step (3) and (5) is 80˜120° C.

9. The strip injection method of the two-color spiral strip injection machine based on PLC control according to claim 6, wherein the step (6) includes the sizing A is in the strip injection inner eye mold, covering the external surface of copper wire under the pressure effect; meanwhile, the sizing B adheres to the surface of sizing A through the outer eye mold, forming screw thread on the surface of sizing A while the outer eye mold is rotating.

10. The strip injection method of the two-color spiral strip injection machine based on PLC control according to claim 6, wherein the sizing A and sizing B are homogeneous or heterogeneous sizing of different colors, and the sizing flow channel is larger than the strip injection channel.
